(19) United States
(12) Patent Application Publication
(10) Pub. No.: US 2012/0216220 A1
(43) Pub. Date: Aug. 23, 2012

(54) CLAMPING DEVICE OF OPTICAL DISC

(75) Inventors: Ko-Han HUANG, Taoyuan County (TW); Jen-Chen Wu, Taoyuan County (TW)

(73) Assignee: QUANTA STORAGE INC., Taoyuan County (TW)

(21) Appl. No.: 13/368,367

(22) Filed: Feb. 8, 2012

(30) Foreign Application Priority Data
Feb. 22, 2011 (TW) 100105973

(51) Int. Cl. G11B 17/04

(52) U.S. Cl. 720/604; G9B/17.013

(57) ABSTRACT

An optical disc clamping device is disclosed. Two concentric rotators with inward/outward rotation are disposed in the inner ring of a stationary seat, and a number of protruded slide grooves support the indented slide base for sliding, such that the stationary seat, the two rotators and the pressing plate are directly suspended to move together. The two-stage rotation enlarges the descent distance of the clamping device and directly descends the pressing plate for clamping the optical disc stably.

This application claims the benefit of Taiwan application Serial No. 100105973, filed Feb. 22, 2011, the subject matter of which is incorporated herein by reference.

### BACKGROUND OF THE INVENTION

1. Field of the Invention

The invention relates in general to an optical disc drive, and more particularly to a slot-in optical disc drive which uses a clamping device to clamp or release an optical disc in conjunction with a spindle motor when loading/unloading the optical disc.

2. Description of the Related Art

The optical disc drive reads/writes the data stored on an optical disc by rotating the optical disc at a high speed. In order to smoothly read/write the optical disc which may wobble violently when rotated at a high speed, the optical disc needs to be clamped stable to avoid the optical disc coming off the disc drive and affecting safety of use.

Referring to FIG. 1, a clamping device according to prior art is shown. The prior art, being Taiwanese Paten Publication No. 201007711, discloses a clamping device 10 disposed around the central hole 11 of an optical disc drive, the ring 12 of the clamping device 10 is driven by the rotation rod 14 to rotate at limited angles along the limiting wall 13. The inner peripheral of the ring 12 faces the central hole 11, and three gaps 15 are distributed over the inner peripheral of the ring 12 at an equal distance of 120 degrees. The stationary end 17 of the elastic piece 16 is disposed in each gap 15, the active end 18 of the elastic piece 16 crosses over and supports the protrusion 19, and further extends to the clamping disc 20 placed in the central hole 11 so as to support the clamping disc 20 at the center of the central hole 11.

According to the prior art, after the optical disc is loaded and placed to a predetermined position, the optical disc drive uses the rotation rod 14 to rotate the ring 12, such that the stationary end 17 of the elastic piece 16 is moved towards the protrusion 19, and when the suspended active end 18 descends the clamping disc 20 to press the optical disc, the clamping disc 20 is attracted by the magnet of the spindle motor (not illustrated in the diagram) to clamp the optical disc. To unload the optical disc, the ring 12 is inversely rotated, the stationary end 17 of the elastic piece 16 is moved away from the protrusion 19, the supported active end 18 lifts the clamping disc 20 to come off the magnet of the spindle motor to release the optical disc.

However, the elastic piece 16 according to the prior art can only drives the clamping disc 20 to descend and cannot provide a downward force, and the force for clamping the optical disc can only rely on the clamping disc 20 and the magnetic force of the spindle motor. If the vibration is too violent, the optical disc cannot be fixed stably, the reading/writing conformity rate of the optical disc is largely affected. In addition, due to the relative displacement occurring between the elastic piece 16 and the clamping disc 20, when the optical disc drive is disposed vertically or tilts to an angle, the clamping disc 20 being moved by imbalanced gravity is no more aligned with the spindle motor and fails to clamp the optical disc stably. Moreover, due to the limitation in the height and disposition space of the protrusion 19, the descent distance of the clamping disc 20 is restricted and is disadvantageous to the thinning of the optical disc drive. Therefore, the optical disc clamping device according to the prior art still has many problems to resolve with regards to the clamping structure.

### SUMMARY OF THE INVENTION

The invention is directed to an optical disc clamping device, which uses two rotators to enlarge the descent distance of the clamping device and press the optical disc for clamping the optical disc stably.

According to one embodiment of the present invention, an optical disc clamping device is provided. Through the mutual suspension and connection between the rotators, the optical disc clamping device can precisely clamp the optical disc and is not affected by the gravity no matter the optical disc drive is disposed horizontally or vertically.

According to an alternate embodiment of the present invention, an optical disc clamping device is provided. The design of two concentric rotators with two-stage rotation avoids element stacking and further contributes to the thinning of optical disc drive.

To achieve the above objects of the invention, an optical disc clamping device including a stationary seat, an outer rotator, and an inner rotator is provided. The stationary seat having a gap is fastened around the central hole of the slot-in optical disc drive. A number of first slide grooves are distributed over the inner ring of the stationery seat. The upper surface of each first slide groove forms a lift tank, and the lower surface of each first slide groove forms a suppression tank. The lift tank and the suppression tank together form a slope tilting towards the same direction. The starting end of the lift tank forms a limiting wall, and the terminal end of the suppression tank forms a wedge surface. The outer rotator having a gap opposite to the gap of the stationary seat is disposed in the inner ring of the stationary seat. A number of first slide bases are disposed at the part of the outer ring of the outer rotator opposite to the first slide groove of the stationary seat. One end of each first slide base is a slide flange sliding in the lift tank of each first slide groove, and the other end of each first slide base is a pressing rod moving along the suppression tank of each first slide groove. A number of second slide grooves are disposed in the inner ring of the outer rotator. The upper surface of each second slide groove forms a lift tank, and the lower surface of each second slide groove forms a suppression tank, wherein the lift tank and the suppression tank together form a slope tilting towards the same direction. The starting end of the lift tank forms a limiting wall, and the terminal end of the suppression tank forms a stopping surface. The inner rotator being a circular plate structure is disposed in the inner ring of the outer rotator and is connected to a rotation rod at the part opposite to the gap of the stationary seat for receiving a driving force provided by the slot-in optical disc drive. A number of second slide bases are disposed at the part of the outer ring of the inner rotator opposite to the second slide grooves of the outer rotator. One end of each second slide base is a slide flange moving along the suppression tank of each second slide groove, and the other end of each second slide base is a pressing rod moving along the suppression tank of each second slide groove.

When the clamping device of the invention is in the initial state, the stationary seat, the outer rotator and the inner rotator are located on the same plane, and the pressing plate of the inner rotator is lifted to avoid blocking the movement of the optical disc. To clamp the optical disc, the slide flange of the inner rotator slides downwardly along the lift tank of the outer rotator and the pressing rod of the inner rotator moves along the suppression tank of the outer rotator until the pressing rod of the inner rotator touches the stopping surface to complete the first stage rotation for descending the pressing plate via the inner rotator. Then, the inner rotator continues to push the stopping surface to rotate the outer rotator, the slide flange of the outer rotator slides downwardly along the lift tank of the stationary seat, and the pressing rod of the outer rotator moves along the suppression tank of the stationary seat until the pressing rod of the outer rotator touches the wedge surface to complete the second stage rotation for descending the pressing plate via the outer rotator. To release the optical disc, the slide flange of the inner rotator slides upwardly along the lift tank of the outer rotator to push the limiting wall of the outer rotator until the slide flange of the outer rotator touches the limiting wall of the stationary seat such that the initial state of the two-stage rotation is resumed and the optical disc is released.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a top view of an optical disc clamping device according to prior art;

FIG. 2 shows a 3D diagram of a slot-in optical disc drive of the invention;

FIG. 3 shows a 3D diagram of a stationary seat of the invention;

FIG. 4 shows a 3D diagram of an outer rotator of the invention;

FIG. 5 shows a 3D explosion diagram of an inner rotator of the invention;

FIG. 6 shows a 3D diagram of partial structure of a clamping device of the invention;

FIGS. 7(a), (b) and (c) are schematic diagrams of clamping an optical disc;

FIG. 8 shows a 3D diagram of a clamping device of the invention at the first stage rotation;

FIG. 9 shows a 3D diagram of a clamping device of the invention at the second stage rotation; and

FIGS. 10(a), (b) and (c) are schematic diagrams of releasing an optical disc.

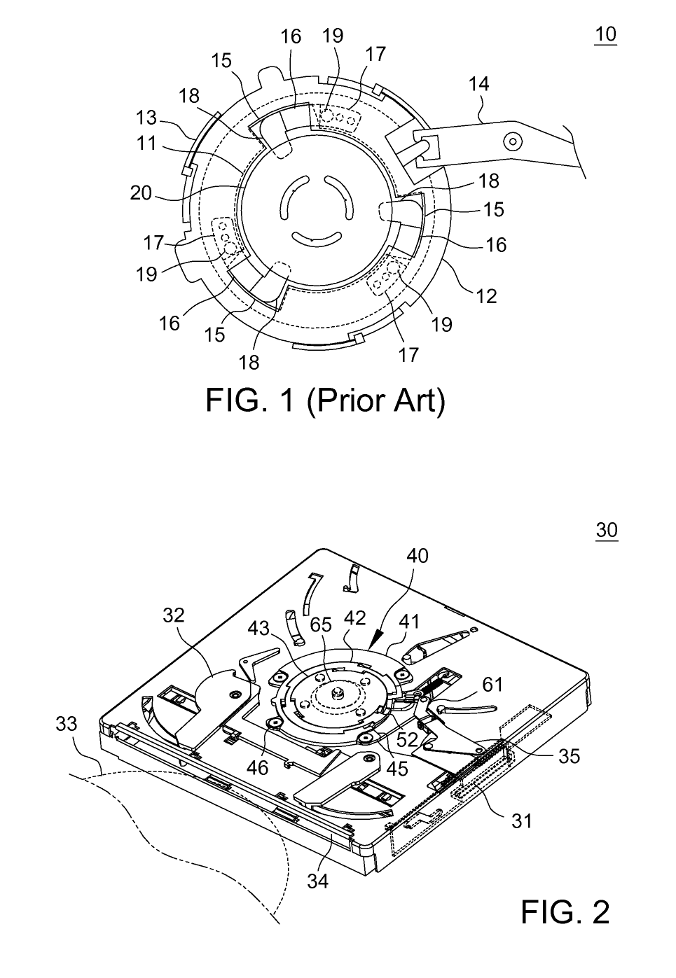

### DETAILED DESCRIPTION OF THE INVENTION

To achieve the objects of the invention, the adopted technologies and effects thereof are disclosed below in a number of exemplarily embodiments with accompanying drawings.

Referring to FIG. 2, a 3D diagram of a slot-in optical disc drive 30 for installing the optical disc clamping device of the invention is shown. The slot-in optical disc drive 30 uses a power unit 31 and a guiding rod 32 to guide an optical disc 33 to be loaded into or unloaded from the slot-in optical disc drive 30 via an entrance 34. The optical disc clamping device 40 is disposed around the central hole of the slot-in optical disc drive 30, and mainly includes a stationary seat 41, an outer rotator 42 and an inner rotator 43. The power unit 31 drives a linking rod 35 so as to provide a driving force to the clamping device 40.

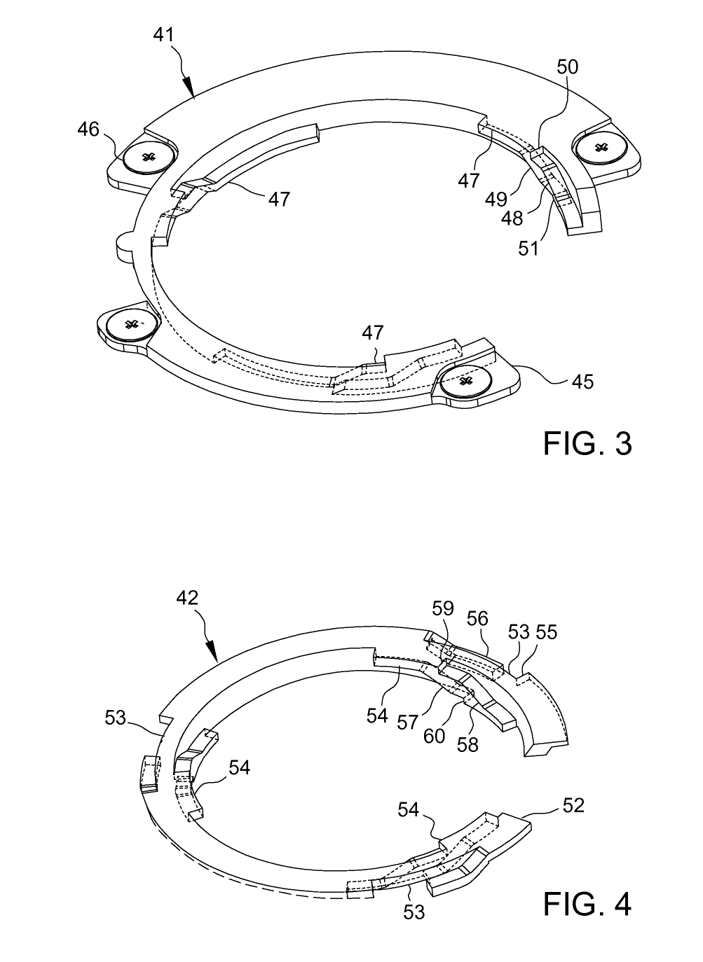

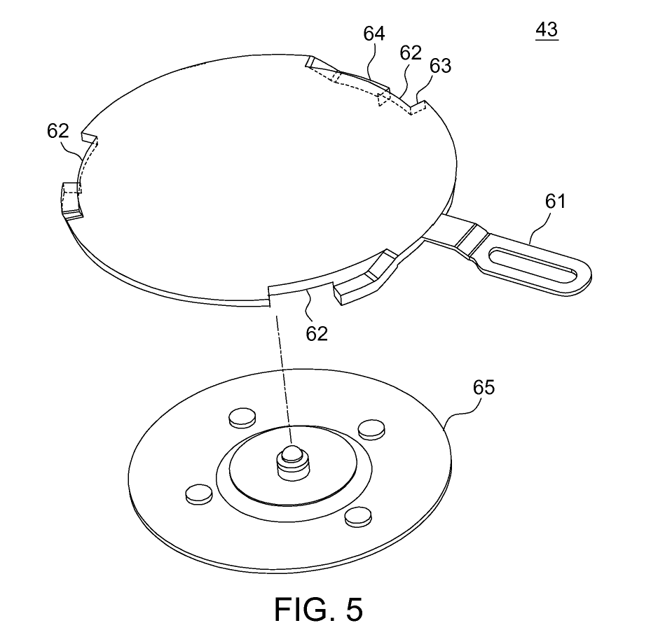

Referring to FIG. 2, FIG. 3, FIG. 4 and FIG. 5. FIGS. 3-5 respectively show the structures of the stationary seat 41, the outer rotator 42 and the inner rotator 43 of the invention. As indicated in FIG. 3, the stationary seat 41 being a ring structure having a gap 45 is fastened around the central hole of the slot-in optical disc drive by a number of screws 46. A number of first slide grooves 47 are distributed over the inner ring of the stationary seat 41. As an exemplification of the present embodiment, three first slide grooves 47 are distributed at an equal distance of 120 degrees. Each first slide groove 47 is protruded from the inner peripheral of the stationary seat 41, and includes a lift tank 48 and a suppression tank 49. The upper surface of the first slide groove 47 forms the lift tank 48, and the lower surface of the first slide groove 47 forms the suppression tank 49. The lift tank 48 and the suppression tank 49 together form a slope tilting towards the same direction. The starting end of the lift tank 48 forms a step-like limiting wall 50, and the terminal end of the suppression tank 49 forms a downwardly inclined wedge surface 51.

As indicated in FIG. 4, the outer rotator 42 is a ring structure having a gap 52 opposite to the gap 45 of the stationary seat 41. The outer diameter of the outer rotator 42 is slightly smaller than the inner diameter of the stationary seat 41, so that the outer rotator 42 can be disposed in the inner ring of the stationary seat 41. At the part of the outer rotator 42 opposite to the first slide groove 47 of the stationary seat 41, a number of first slide bases 53 are indented into the outer ring of the outer rotator 42 and a number of second slide grooves 54 are protruded from the inner ring of the outer rotator 42. As an exemplification of the present embodiment, three first slide bases 53 and three second slide grooves 54 are respectively distributed at an equal distance of 120 degrees. One end of each indented first slide base 53 is a slide flange 55 and the other end of each indented first slide base 53 is a pressing rod 56 inclined downwardly, wherein the height of the pressing rod 56 is smaller than that of slide flange 55. Each second slide groove 54 of the outer rotator 42 has a lift tank 57 and a suppression tank 58 which are similar to the lift tank 48 and the suppression tank 49 of the first slide groove 47. The starting end of the lift tank 57 forms a step-like limiting wall 59. The terminal end of the suppression tank 58 forms a stopping surface 60.

As indicated in FIG. 5, the inner rotator 43 is a circular plate, and a rotation rod 61 is connected to the part of the inner rotator 43 opposite to the gap 45 of the stationary seat 41. The outer diameter of the inner rotator 43 is slightly smaller than the inner diameter of the outer rotator 42, so that the inner rotator 43 can be disposed in the inner ring of the outer rotator 42. At the part of the inner rotator 43 opposite to the second slide groove 54 of the outer rotator 42, a number of second slide bases 62 are indented into the outer ring of the inner rotator 43. As an exemplification of the present embodiment, three second slide bases 62 are distributed at an equal distance of 120 degrees. The structure of the indented second slide base 62 is similar to that of the first slide base 53. One end of the second slide bases 62 is a slide flange 63, and the other end of the second slide bases 62 is a pressing rod 64 inclined downwardly, wherein the height of the pressing rod 64 is smaller than that of the slide flange 63. Besides, a pressing plate 65 is fixed at the center of the bottom surface of the inner rotator 43 for pressing the optical disc 33.

Referring to FIG. 2, the processes for assembling the clamping device 40 are shown. Firstly, the gap 45 of the stationary seat 41 is directed to face the linking rod 35, and the stationary seat 41 is fixed around the central hole of the slot-in optical disc drive 30 by a number of screws 46. Next, the gap 52 of the outer rotator 42 is aligned with the gap 45 of the stationary seat 41, so that the outer rotator 42 is disposed in the inner ring of the stationary seat 41. Then, the rotation rod 61 of the inner rotator 43 is aligned with the gap 45 of the stationary seat 41, so that the inner rotator 43 is disposed in the inner ring of the outer rotator 42. The rotation rod 61 is extended from the gap 45 of the stationary seat 41 so as to be connected to the linking rod 35 for receiving the driving force provided by the power unit 31.

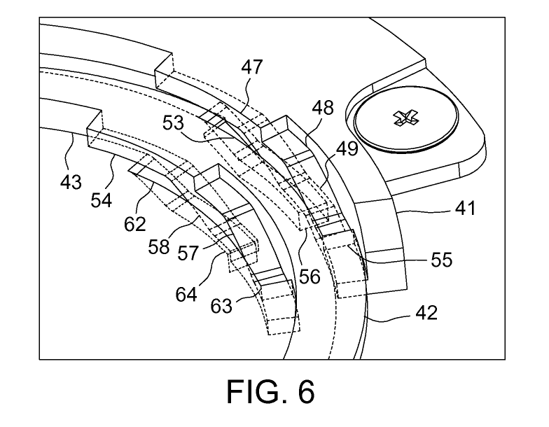

Referring to FIG. 6, a 3D diagram of partial structure of a clamping device 40 after assembly is shown. When the outer rotator 42 is disposed in the inner ring of the stationary seat 41, the slide flange 55 of the first slide base 53 indented into the outer rotator 42 slides in the lift tank 48 of the first slide groove 47 protruded from the stationary seat 41, and the pressing rod 56 of the outer rotator 42 moves along the suppression tank 49 of the first slide groove 47, so that the outer rotator 42 is supported in the inner ring of the stationary seat 41. Similarly, when the inner rotator 43 is disposed in the inner ring of the outer rotator 42, the slide flange 63 of the second slide base 62 indented into the inner rotator 43 slides in the lift tank 57 of the second slide groove 54 protruded from the outer rotator 42, and the pressing rod 64 of the inner rotator 43 moves along the suppression tank 58 of the second slide groove 54, so that the inner rotator 43 is supported in the inner ring of the outer rotator 42.

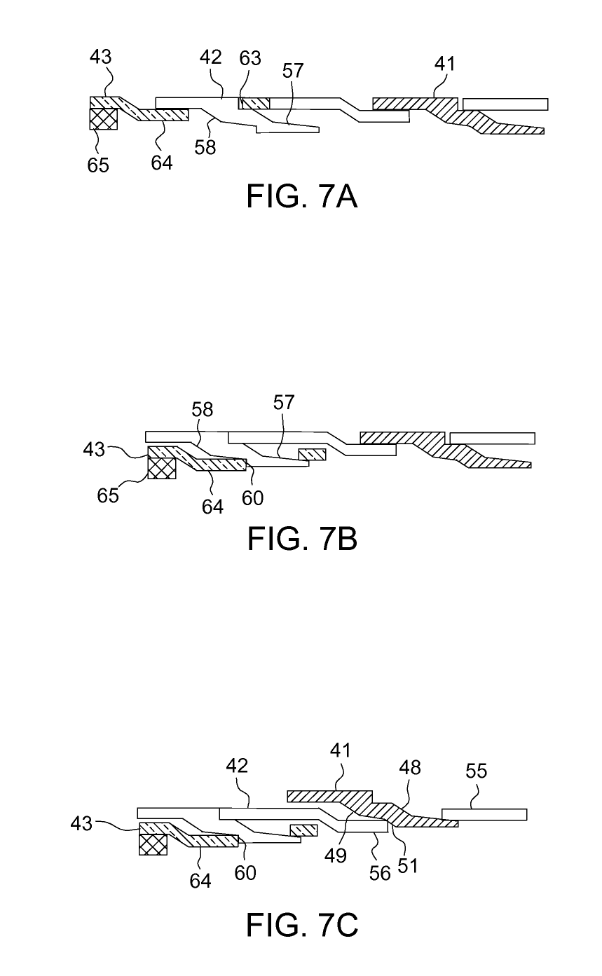

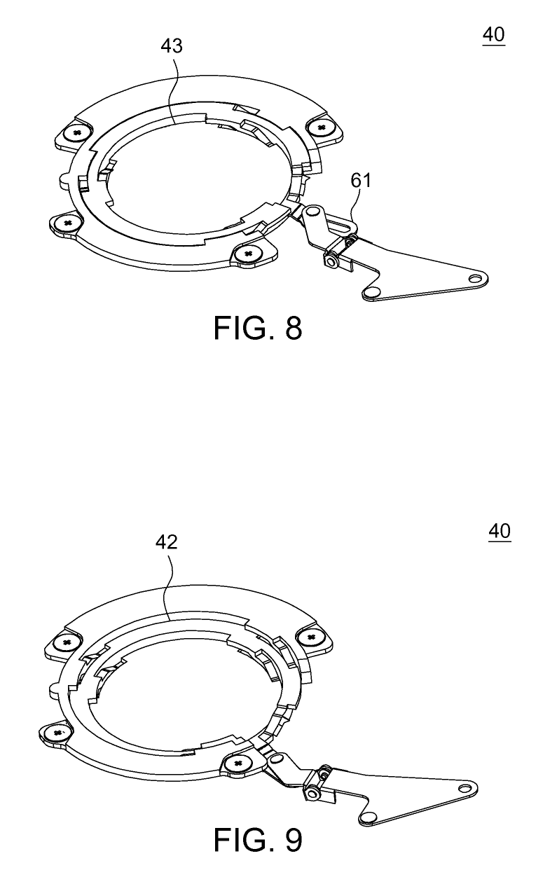

Referring to FIG. 2, FIG. 7, FIG. 8 and FIG. 9. FIGS. 7(a), (b) and (c) are diagrams showing partial structure of the clamping device 40 of FIG. 6 for clamping an optical disc. FIG. 8 shows the state of the first stage rotation of the clamping device 40 of FIG. 7(b). FIG. 9 shows the state of the second stage rotation of the clamping device 40 of FIG. 7(c). FIG. 7(a) shows the initial state of the clamping device 40 of the invention as indicated in FIG. 2. That is, the stationary seat 41, the outer rotator 42 and the inner rotator 43 are located on the same plane, such that the pressing plate 65 disposed under the inner rotator 43 is lifted to avoid blocking the movement of the optical disc and become available for clamping the optical disc. After the optical disc enters the predetermined position, the power unit 31 drives the linking rod 35 to move the rotation rod 61 along the gap 45 of the stationary seat 41 so as to rotate the inner rotator 43. The slide flange 63 of the inner rotator 43 slides downwardly along the lift tank 57, such that the inner rotator 43 descends, and the pressing rod 64 of the inner rotator 43 moves along the suppression tank 58.

As indicated in FIG. 7(b), when the pressing rod 64 touches and is blocked by the stopping surface 60 formed at the terminal end of the suppression tank 58, the inner rotator 43 descends to the lowest point of the lift tank 57, and the first stage rotation for descending the pressing plate 65 via the inner rotator 43 is thus completed. FIG. 8 shows an actual appearance of the clamping device 40 at the first stage rotation for descending the inner rotator 43. As the rotation rod 61 continues to rotate the inner rotator 43 as indicated in FIG. 7(c), the pressing rod 64 of the inner rotator 43 directly pushes the stopping surface 60, such that the outer rotator 42 rotates, the slide flange 55 of the outer rotator 42 slides downwardly along the lift tank 48 of the stationary seat 41, the pressing rod 56 of the outer rotator 42 moves along the suppression tank 49, the outer rotator 42 continues to descend and so does the inner rotator 43 until the pressing rod 56 touches the wedge surface 51 formed at the terminal end of the suppression tank 49. Since the stationary seat 41 is fixed, the wedge surface 51 is also fixed. The pressing rod 56 presses the downwardly inclined wedge surface 51, such that the wedge surface 51 presses the outer rotator 42 and the inner rotator 43 at the same time, and the pressing plate 65 presses the optical disc downwardly to complete the second stage rotation for descending the pressing plate 65 via the outer rotator 42. FIG. 9 shows an actual appearance of the clamping device 40 at the second stage rotation for descending the outer rotator 42.

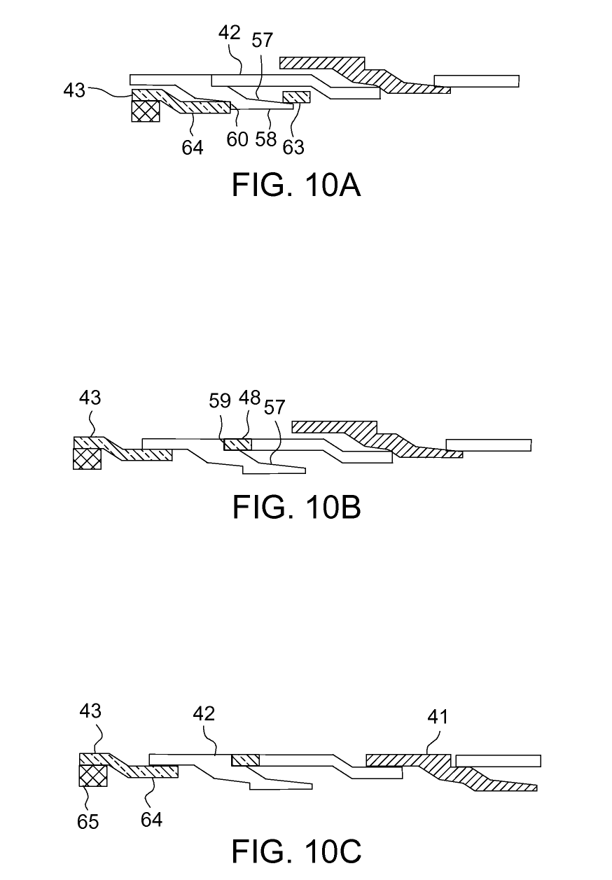

Referring to FIG. 2 and FIG. 10. FIGS. 10(a), (b) and (c) are schematic diagrams of a clamping device 40 releasing an optical disc. The processes of releasing an optical disc by the clamping device 40 are opposite to the above processes of clamping an optical disc. As indicated in FIG. 10(a), when the optical disc is released, the power unit 31 moves the rotation rod 61 in an opposite direction to inversely rotate the inner rotator 43. The slide flange 63 of the inner rotator 43 slides upwardly along the lift tank 57, and the pressing rod 64 of the inner rotator 43 which comes off the stopping surface 60 moves along the suppression tank 58. As indicated in FIG. 10(b), when the slide flange 63 touches and is blocked by the limiting wall 59 formed at the starting end of the lift tank 57, the inner rotator 43 is lifted to the highest point of the lift tank 57.

As indicated in FIG. 10(c), the rotation rod 61 continue to inversely rotate the inner rotator 43, the slide flange 63 of the inner rotator 43 directly pushes the limiting wall 59 and forces the outer rotator 42 to rotate inversely, the slide flange 55 of the outer rotator 42 is lifted along the lift tank 48 of the stationary seat 41, the pressing rod 56 of the outer rotator 42 moves along the suppression tank 49, and the pressing rod 56 comes off the wedge surface 51, so that the outer rotator 42 is lifted so as to raise the inner rotator 43 and the pressing plate 65 sequentially until the slide flange 55 touches the limiting wall 59 formed at the starting end of the lift tank 48. Since the stationary seat 41 is fixed, the limiting wall 59 is also fixed, such that the rotation of the outer rotator 42 is blocked, and the clamping device 40 returns to the initial state of the two-stage rotation.

According to the optical disc clamping device of the invention, the descent distance of the clamping device is enlarged through the design of two rotators with inward/outward rotation. The rotators directly move the pressing plate to press the optical disc, so that the displacement of the elastic piece is avoided and the optical disc is clamped stably. Meanwhile, the design of two concentric rotators avoids element stacking and further contributes to the thinning of optical disc drive. Besides, through the mutual suspension and connection among the stationary seat, two rotators and the pressing plate, the displacement of the clamping device caused by gravity is avoided and the optical disc is clamped stably no matter the optical disc drive is disposed horizontally or vertically.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical disc clamping device fastened around a central hole of a slot-in optical disc drive, wherein the clamping device comprises:
a stationary seat fastened around the central hole, wherein the stationary seat has a gap, a plurality of first slide grooves are distributed over an inner ring of the stationary seat, an upper surface of each first slide groove forms a lift tank, a lower surface of each first slide groove forms a suppression tank, the lift tank and the suppression tank together form a slope tilting towards the same direction, a limiting wall is formed at a starting end of the lift tank, and a wedge surface is formed a terminal end of the suppression tank; and
an outer rotator being a ring structure having a gap opposite to the gap of the stationary seat, wherein the outer rotator is disposed in the inner ring of the stationary seat, a plurality of first slide bases are disposed at the part of an outer ring of the outer rotator opposite to the first slide groove of the stationary seat, one end of each first slide base is a slide flange sliding in the lift tank of the first slide groove, the other end of each first slide base is a pressing rod moving along the suppression tank of the first slide groove, a plurality of second slide grooves are disposed in an inner ring of the outer rotator, an upper surface of each second slide groove forms a lift tank, an lower surface of each second slide groove forms a suppression tank, the lift tank and the suppression tank together form a slope tilting towards the same direction, a starting end of the lift tank forms a limiting wall, and a terminal end of the suppression tank forms a stopping surface; and
an inner rotator being a circular plate, wherein a pressing plate is fixed at the center of a bottom surface of the inner rotator, the inner rotator is connected to a rotation rod at the part opposite to the gap of the stationary seat for receiving a driving force provided by the slot-in optical disc drive, a plurality of second slide bases are disposed at the part of an outer ring of the inner rotator opposite to the second slide grooves of the outer rotator, one end of each second slide base is a slide flange moving along the suppression tank of each second slide groove, and the other end of each second slide base is a pressing rod moving along the suppression tank of each second slide groove.

2. The optical disc clamping device according to claim 1, wherein three first slide grooves are distributed over the inner ring of the stationary seat at an equal distance of 120 degrees.

3. The optical disc clamping device according to claim 2, wherein three first slide bases are indented into the outer ring of the outer rotator at an equal distance of 120 degrees and three second slide grooves are protruded from the inner ring of the outer rotator at an equal distance of 120 degrees.

4. The optical disc clamping device according to claim 3, wherein three second slide bases are indented into the outer ring of the inner rotator at an equal distance of 120 degrees.

5. The optical disc clamping device according to claim 1, wherein the pressing rods of the first slide bases and the second slide bases are inclined downwardly and are lower than the slide flanges of the first and second slide bases.

6. The optical disc clamping device according to claim 1, wherein when the clamping device is in the initial state, the stationary seat, the outer rotator and the inner rotator are located on the same plane, and the pressing plate is lifted to avoid blocking the movement of the optical disc.

7. The optical disc clamping device according to claim 6, wherein the slide flange of the inner rotator slides downwardly along the lift tank of the outer rotator, and the pressing rod of the inner rotator moves along the suppression tank of the outer rotator until the pressing rod of the inner rotator touches the stopping surface to complete a first stage rotation for descending the pressing plate via the inner rotator.

8. The optical disc clamping device according to claim 7, wherein the inner rotator pushes the stopping surface to rotate the outer rotator, the slide flange of the outer rotator slides downwardly along the lift tank of the stationary seat, and the pressing rod of the outer rotator moves along the suppression tank of the stationary seat until the pressing rod of the outer rotator touches the wedge surface to complete a second stage rotation for descending the pressing plate via the outer rotator.

9. The optical disc clamping device according to claim 8, wherein the wedge surface is a downwardly inclined surface, and when the outer rotator is pressed by the wedge surface, the inner rotator is pressed at the same time for pressing the optical disc.

10. The optical disc clamping device according to claim 8, wherein when the slide flange of the inner rotator slides upwardly along the lift tank of the outer rotator to push the limiting wall of the outer rotator until the slide flange of the outer rotator touches the limiting wall of the stationary seat, the two-stage rotation is resumed and the optical disc is released.
